(19) United States
(12) Patent Application Publication
(10) Pub. No.: US 2022/0134865 A1
(43) Pub. Date: May 5, 2022

(54) Method for Operating a Motor Vehicle, Control Device, and Motor Vehicle

(71) Applicant: ZF Friedrichshafen AG, Friedrichshafen (DE)

(72) Inventors: Stefan Beck, Eriskirch (DE); Fabian Kutter, Kressbronn (DE); Michael Wechs, Weißensberg (DE); Johannes Kaltenbach, Friedrichshafen (DE); Matthias Horn, Tettnang (DE); Peter Ziemer, Tettnang (DE); Thomas Martin, Weissensberg (DE); Oliver Bayer, Hörbranz (AT); Martin Brehmer, Tettnang (DE); Thomas Kroh, Lindau (DE); Max Bachmann, Friedrichshafen (DE)

(21) Appl. No.: 17/436,160

(22) PCT Filed: Oct. 15, 2019
(86) PCT No.: PCT/EP2019/077952

§ 371 Date: Sep. 3, 2021

(30) Foreign Application Priority Data
Mar. 5, 2019 (DE) 10 2019 202 945.0

(51) Int. Cl. B60K 6/547; B60K 6/26; B60K 6/387; F16H 3/091

(52) U.S. Cl. CPC B60K 6/547; B60K 6/26; F16H 2200/0008; F16H 3/091; F16H 2200/0047; B60K 6/387

(57) ABSTRACT

A hybrid transmission device (3) includes at least one electric motor (EM1, EM2), a first transmission input shaft (7), and a second transmission input shaft (9) mounted on the first transmission input shaft (7). A connecting clutch (K3) is configured for a selective rotationally fixed connection of the first transmission input shaft (7) and the second transmission input shaft (9). The second transmission input shaft (9) includes an end (11) pointing toward the outer side of the hybrid transmission device (3) and an end (13) pointing toward the inner side of the hybrid transmission device (3). The connecting clutch (K3) is arranged at the end (13) of the second transmission input shaft (9) pointing toward the inner side of the hybrid transmission device (3).

### CROSS-REFERENCE TO RELATED APPLICATIONS

The present application is related and has right of priority to German Patent Application No. 102019202945.0 filed in the German Patent Office on Mar. 5, 2019 and is a nationalization of PCT/EP2019/077952 filed in the European Patent Office on Oct. 15, 2019, both of which are incorporated by reference in their entirety for all purposes.

### FIELD OF THE INVENTION

The invention relates generally to a method for operating a motor vehicle having an internal combustion engine and a hybrid transmission device, wherein the hybrid transmission device includes a gear change transmission having multiple gear steps and at least one drive device.

### BACKGROUND

It is known to utilize hybrid transmission devices to reduce the carbon dioxide (CO2) emissions of motor vehicles. A hybrid transmission device is understood to be a transmission device, onto which an internal combustion engine and at least one further drive device are couplable. It is known to hybridize all automated transmissions, for example, automatic transmissions and dual clutch transmissions. DE10 2011 005 451 A1 describes a transmission, which includes two electric motors and has five forward gears and one reverse gear. During the operation, both electric motors can drive the motor vehicle.

### SUMMARY OF THE INVENTION

Example aspects of the present invention is to provide a method for operating a motor vehicle, which offers greater functionality for front-mounted transverse applications.

Example aspects of the present invention provide that, in a method of the type mentioned at the outset, at least one gear step is acted upon by drive torque exclusively by the drive device of the hybrid transmission device.

A gear step refers to a ratio between two shafts. The motor vehicle has at least two of these gear steps. At least one of the gear steps is designed for the drive device of the hybrid transmission device and is acted upon by drive torque only via the drive device. The further gear steps can be arbitrarily acted upon, in principle, whether by the internal combustion engine, the aforementioned drive device, or further drive devices. Although the configuration for the internal combustion engine or the drive device or both is reflected in the reduction ratio, it is always dependent on the configuration of the internal combustion engine and the drive device. A generally valid statement with respect to the reduction ratio can therefore not be made.

Preferably, precisely one gear step can be acted upon by drive torque exclusively by the drive device of the hybrid transmission device. While an application by the internal combustion engine as well as by a drive device of the hybrid transmission device is reasonable in most of the gear steps, a specific gear step for a drive device of the hybrid transmission device provides an increase in efficiency when only the drive device is utilized, for example, during electric travel.

Preferably, at least one gear step can be acted upon by drive torque at different times by the at least one drive device of the hybrid transmission device and the internal combustion engine. Alternatively or additionally, at least one gear step can be acted upon by drive torque simultaneously by the at least one drive device of the hybrid transmission device and the internal combustion engine. A gear step can therefore be utilized in two different ways by the different drive types, the internal combustion engine and the at least one drive device: simultaneously or at different times.

Preferably, precisely four gear steps can be operated by the internal combustion engine. With this gear step, in particular, all ground speeds in city traffic and on country roads can be efficiently covered. Only an overdrive gear for highway travel is not represented.

Advantageously, the first drive device and the second drive device can be power-shifted. A powershift is understood here, as usual, to mean that no interruption of tractive force occurs at the output of the hybrid transmission device during a gear change, for example, of the first drive device. A reduction of the torque present at the output is possible, but a complete interruption is not.

As a result, the motor vehicle can be continuously driven in large speed ranges, for example, exclusively electrically, wherein the ratio, i.e., the gear, is selected in each case so as to be optimized with respect to the rotational speed and torque of the drive device.

Advantageously, as a result, an optimal gear step of the transmission of the hybrid transmission device can be utilized for all forward gears implemented with the first and the second drive devices. The described example concept is therefore substantially more flexible in comparison to arrangements, in which, although an internal combustion engine can also operate an electric motor as a generator and a second electric motor is present, the internal combustion engine always drives the same electric motor as a generator.

Advantageously, the first drive device can be utilized as a generator in at least two forward gears. As forward gears, a distinction is made, among other things, between internal-combustion-engine, hybrid, fluidic, and electric forward gears. An internal-combustion-engine forward gear is a gear, in which only the internal combustion engine is utilized as the drive source. An electric gear, therefore, is a gear, in which one or both drive device(s) designed as an electric motor or as electric motors is/are utilized as the drive source. A fluidic gear is a gear, in which one or both drive device(s) designed as a fluid power machine or as fluid power machines is/are utilized as the drive source. A hybrid forward gear is a gear, in which the internal combustion engine as well as at least one of the drive devices of the hybrid transmission device are utilized as the drive source. An appropriate configuration of a hybrid transmission device is described in detail further below.

Preferably, the first drive device can be utilized in forward gears without the internal combustion engine, i.e., for example, electric or fluidic forward gears, as a generator or as an auxiliary drive. If the first drive device is utilized as a generator in electric or fluidic forward gears, only the second drive device is the drive source of the motor vehicle. If the battery has a sufficiently high state of charge, the first drive device can also provide an additional torque in electric forward gears. Advantageously, the first drive device is utilized as a generator in electric or fluidic forward gears until the battery is fully charged or until a demand for acceleration arises, which makes it necessary to include the first drive device as an auxiliary drive. If the state of charge of the battery is sufficiently high, the first drive device can then assist the second drive device. Due to the fact that the operation as a generator in electric or fluidic forward gears is intended as a standard use, the state of charge of the battery can be kept high.

Preferably, the first drive device can also be utilized as a generator or as an auxiliary drive in hybrid forward gears. If the first drive device is utilized as a generator in a hybrid forward gear, one portion of the torque output by the internal combustion engine is provided for driving the first drive device and another portion is provided for driving the motor vehicle.

Preferably, the first drive device can be utilized, at least intermittently, as a generator in at least one internal-combustion-engine forward gear. If the first drive device is also utilized for synchronizing the rotational speeds of the shafts, there may be time periods, in which an operation as a generator is not possible. In addition, it can be provided in the internal combustion engine-driven mode to transmit the entirety of the torque of the internal combustion engine to the wheels. An operation of the first drive device as a generator is ruled out in this case as well. Advantageously, the first drive device can be continuously utilized as a generator in at least one internal-combustion-engine forward gear, however. This can be achieved by an appropriate layout of the sequences.

Preferably, the second drive device can output torque to the drive output while the first drive device is shifted. In other words, the gear step is changed, via which the first drive device transmits torque to the drive output.

Preferably, the first drive device can output torque to the drive output while the second drive device is shifted. This means, the gear step is changed, via which the second drive device transmits torque to the drive output. It may therefore also be stated that the drive devices are power shiftable with each other. The internal combustion engine therefore does not need to be started for a gear change during electric travel.

Preferably, the first drive device can be utilized as the main drive source in a crawler gear, in particular an electric or fluidic crawler gear, and the second drive device can be utilized as the main drive source in at least one other forward gear, in particular an electric or fluidic or hybrid forward gear. A crawler gear, as is known, is a gear for traveling at a low speed, for example, in a traffic jam.

Advantageously, the second drive device can be utilized as the main drive source in at least two other forward gears, in particular, two other electric and/or fluidic and/or hybrid forward gears. In particular, the second drive device can be utilized as the main drive source in all other forward gears, in particular, all other electric and/or fluidic and/or hybrid forward gears. In other words, advantageously, the first drive device can be utilized as the main drive source exclusively in a crawler gear, in particular, an electric or fluidic crawler gear.

The main drive source is considered to be the drive device of all the drive devices of the motor vehicle, including the internal combustion engine in this case, that outputs the most torque at the drive output. In electric or fluidic forward gears, this is always a drive device of the hybrid transmission device. In internal-combustion-engine gears, this is always the internal combustion engine. In hybrid forward gears, this can vary or depend on the operating condition.

Preferably, the second drive device can be utilized as an electric or fluidic and/or hybrid main drive source in all hybrid forward gears. In this case, the second drive device either outputs more torque than the first drive device or more torque in comparison to the first drive device and in comparison to the internal combustion engine.

Preferably, the first drive device can be rotationally fixed to the internal combustion engine in all internal-combustion-engine forward gears and/or during an internal-combustion-engine gear change. In this case, a constant connection exists between the internal combustion engine and the first drive device during internal combustion engine-driven travel. Preferably, the first drive device can be utilized, at least intermittently, as a generator in all forward gears except for the crawler gear. In addition, the first drive device can be rotationally fixed in all hybrid forward gears.

Preferably, the second drive device can be utilized for an electric or fluidic forward starting operation. In this case, the second drive device can be coupled, advantageously, to the gear-step gears of the second gear. The starting operation is always performed by the second drive device. The second drive device can preferably be utilized as a sole drive source for the starting operation. The second drive device can also be utilized for electric or fluidic travel in reverse. Preferably, it can also be provided here that the second drive device is the sole drive source during travel in reverse. In this case, there are no internal-combustion-engine or hybrid reverse gears.

Advantageously, the sub-transmissions of the transmission can be connected in order to form at least one gear, in particular, an internal-combustion-engine and/or hybrid and/or electric and/or fluidic forward gear. Preferably, the sub-transmissions are connected in order to form all even forward gears.

The hybrid transmission device for carrying out the method is described more precisely in the following. This is an example configuration, with which the described method is particularly easily implemented. Features described with respect to the hybrid transmission device can therefore also be utilized in the described method.

The transmission of the hybrid transmission device is advantageously designed as a gear change transmission. The hybrid transmission device has at least two discrete gear steps in this case.

Advantageously, the gear change transmission can include at least two, in particular precisely two, sub-transmissions. This allows for increased functionality and, for example, tractive force support during a gear change, in particular an internal-combustion-engine gear change as well as an electric gear change.

Preferably, at least one of the sub-transmissions can be designed as a gear change transmission. In particular, two or more, in particular precisely two, sub-transmissions can be designed as gear change transmissions. In this case, one sub-transmission has at least two gear steps, and the further sub-transmission has at least one gear step.

Advantageously, one sub-transmission can have precisely three gear steps, in particular forward gear steps. In addition, a second sub-transmission can have precisely two gear steps, in particular forward gear steps.

Advantageously, the gear change transmission includes gearwheels and shift elements. The gearwheels are preferably designed as spur gears.

Preferably, the transmission of the hybrid transmission device is designed as a stationary transmission. In stationary transmissions, the axles of all gearwheels in the transmission are fixed in relation to the transmission housing.

Preferably, the gear change transmission is designed as a transmission of a countershaft design. Preferably, the gear change transmission is designed as a spur gear drive. The gearwheels are designed as spur gears in this case.

In addition, the transmission can be designed as a dual clutch transmission. It has two transmission input shafts in this case.

Preferably, the transmission can include at least two shafts. These are necessary for forming the gear steps when the transmission is designed as a stationary transmission.

In addition, the transmission preferably includes at least one, in particular at least two, transmission input shafts. Preferably, the transmission includes precisely two transmission input shafts. With three or more transmission input shafts, although a larger number of sub-transmissions can be produced, it has been proven that the described functionality can be achieved already with two transmission input shafts.

Preferably, the first transmission input shaft is designed as a solid shaft. Regardless of the design of the first transmission input shaft, the second input shaft is preferably mounted on the first transmission input shaft, i.e., the second input shaft is arranged coaxially thereto and encloses the first input shaft. The second input shaft is a hollow shaft in this case. In this case, the clutch for connecting the first transmission input shaft with an internal combustion engine and, advantageously, the clutch for connecting the second transmission input shaft with an internal combustion engine are also directly followed in the axial direction, on the engine side, by the second transmission input shaft.

Preferably, the hybrid transmission device can include at least one, in particular precisely one, countershaft. In the case that a single countershaft is utilized, a single point of connection to the differential is present. As a result, installation space can be saved, which is the case in the radial direction as well as in the axial direction.

Therefore, the transmission in one preferred example embodiment includes precisely three shafts, namely two transmission input shafts and one countershaft, which is also the output shaft in this case.

In an all-wheel example variant of the transmission, one shaft is always added, which, as a power take-off, drives the second motor vehicle axle.

A gear step, as already described at the outset, is a mechanically implemented ratio between two shafts. The overall gear ratio between the internal combustion engine or the drive device and the wheel has further ratios, wherein the ratios upstream from a gear step, the pre-ratios, can depend on the output that is utilized. The post-ratios are usually identical. In an example embodiment shown further below, the rotational speed and the torque of a drive device are transmitted multiple times, namely by at least one gearwheel pair between the output shaft of the drive device and a transmission input shaft. This is a pre-ratio. This is followed by a gearwheel pair of a gear step with a ratio dependent on the gear step. Finally, this is followed by a gearwheel pair between the countershaft and the differential, as a post-ratio. A gear has an overall gear ratio that depends on the input and the gear step. Unless indicated otherwise, a gear relates to the utilized gear step.

Merely for the sake of clarity, it is pointed out that the ascending numbers of the gear steps refer, as usual, to a descending ratio. A first gear step G1 has a higher ratio than a second gear step G2, etc.

If torque is transmitted from the internal combustion engine via the first gear step G1, this is referred to as an internal-combustion-engine gear V1. If the second drive device and the internal combustion engine simultaneously transmit torque via the first gear step G1, this is referred to as a hybrid gear H11. If only the second drive device transmits torque via the first gear step G1, this is referred to as an electric gear E1.

In the following, gear steps refer to forward gear steps. Preferably, the transmission of the hybrid transmission device has at least three gear steps or gear stages. The gearwheels of a gear step can be arranged in a gear plane when the gear step includes two gear-step gears. In a first example embodiment, the transmission has at least four gear steps or gear stages. In a further example embodiment, the transmission preferably has at least five, in particular precisely five, gear steps or gear stages.

Preferably, the transmission of the hybrid transmission device has one gear plane more than forward gear steps. In the case of five gears, this is six gear planes. The gear plane for connecting the drive output, for example, a differential, is included in the count.

In a first example alternative, all gear steps can be utilized in an internal combustion engine-driven and electric or fluidic manner. As a result, a maximum number of gears can be obtained given a low number of gear steps. In a second example alternative, at least one, in particular precisely one, gear step is reserved solely for a drive device of the hybrid transmission device, i.e., an electric gear step. In this example embodiment, at least one other gear step can be usable for transmitting torque of the internal combustion engine as well as of a drive device. Preferably, all further gear steps are usable for transmitting torque of the internal combustion engine as well as of a drive device.

Advantageously, the hybrid transmission device and/or the transmission can be designed to be free from a reversing gearwheel for reversing the direction. Therefore, the reverse gear is not produced via the internal combustion engine, but rather via the electric motor or at least one of the electric motors. In this case, for example, the first gear step or the second gear step can be utilized.

Preferably, gear-step gearwheels for all odd gear steps, in particular forward gear steps, can be arranged on the first transmission input shaft. In addition, gear-step gears of all even gear steps, in particular forward gear steps, can preferably be arranged at the second transmission input shaft. Gear-step gears, which are also referred to as gear-step gearwheels, can be designed as fixed gears or idler gears. The gear-step gears are referred to as gear-step gears, because the gear-step gears are associated with a gear step.

Preferably, the highest even gear step and/or one of the gear-step gears associated therewith are/is located at the axial end of the transmission input shaft that supports one of the gear-step gearwheels of the highest even gear step. Preferably, the highest even gear step is the fourth gear step and/or the transmission input shaft is the second transmission input shaft. Alternatively, the transmission input shaft can be the first transmission input shaft.

Preferably, the highest odd gear step and/or one of the gear-step gears associated therewith are/is located at the axial end of the transmission input shaft that supports one of the gear-step gearwheels of the highest odd gear step. Preferably, the highest odd gear step is the fifth gear step and/or the transmission input shaft is the first transmission input shaft.

Preferably, the highest electric gear step and/or one of the gear-step gears associated therewith are/is located at the axial end of the transmission input shaft that supports one of the gear-step gearwheels of the highest electric gear step. Preferably, the highest electric gear step is a second gear step and/or the transmission input shaft is the second transmission input shaft.

In a first example embodiment, in sum, the gear-step gearwheels of the highest gear steps can be located at the axial outer sides of the shafts, in particular of the transmission input shafts. If the transmission has five forward gear steps, the fourth gear step and the fifth gear step, i.e., the gearwheels thereof, are arranged axially externally and the other gear steps and the gearwheels of the other gear steps are arranged within the two gear steps of the fourth gear step and the fifth gear step.

Preferably, the gear-step gears of the fourth gear step and of the second gear step can be arranged on the second transmission input shaft from the outer side of the hybrid transmission device toward the inner side.

Alternatively, the gear-step gears of an electric gear step and of the first gear step can be arranged on the second transmission input shaft from the outer side of the hybrid transmission device toward the inner side.

Preferably, the gear-step gears of the fifth gear step, of the first gear step, and of the third gear step can be arranged on the first transmission input shaft from the outer side of the hybrid transmission device toward the inner side.

Alternatively, the gear-step gears of the fourth gear, of the second gear, and of the third gear can be arranged on the first transmission input shaft from the outer side of the hybrid transmission device toward the inner side.

Preferably, the hybrid transmission device can include at least two, in particular precisely two, drive devices. An arrangement of one or multiple drive device(s) that act(s) at a certain point of the hybrid transmission device counts as a drive device. This means, for example, in an example embodiment of the drive devices as electric motors, that multiple small electric motors can also be considered to be one electric motor if the multiple small electric motors summarize torque at a single starting point.

Advantageously, at least one drive device each can be associated with the first transmission input shaft as well as with the second transmission input shaft. The gears implemented via the first transmission input shaft and the gears implemented via the second transmission input shaft form a sub-transmission in each case. It may therefore also be stated that at least one drive device is associated with each sub-transmission. Preferably, the hybrid transmission device includes at least two, in particular precisely two, sub-transmissions.

Preferably, at least one of the drive devices is designed as a generator.

Preferably, the first drive device and/or the second drive device are/is designed as a motor and as a generator.

Preferably, the drive device is connected to the highest gear step of the transmission. In the case of two drive devices, it is advantageously provided, in a first example embodiment, that the two drive devices are connected to the two highest gear steps. In a further example embodiment, it is provided that the drive devices are each attached to the highest gear step of a particular sub-transmission. The two highest gear steps can also be arranged in a single sub-transmission. In addition, the drive devices can each be attached to the highest gear steps on a transmission input shaft.

Preferably, the drive device is connected to an axially externally situated gear step, more precisely, to one of the gearwheels of the gear step, of the transmission. In the case of two drive devices, it is advantageously provided that both are connected to an axially externally situated gear step of the transmission. As a result, the center distance of the connection points can be maximized.

At this point, it is to be pointed out that, in the present invention, a connection or operative connection refers to any power flow-related connection, also across other components of the transmission. A connection, however, refers to the first connecting point for transmitting drive torque between the prime mover and the transmission.

A connection to a gear step, i.e., one of the gear-step gearwheels, can take place via a gearwheel. An additional intermediate gear may be necessary, in order to bridge the center distance between the output shaft of the drive device and the transmission input shaft. Due to the connection of the drive device to a gear-step gearwheel, a further gear plane can be avoided, which would be present only for the connection of the drive device.

Advantageously, at least one of the axially external gear-step gears, which are arranged on the axis of the transmission input shafts, can be designed as a fixed gear. Preferably, both axially external gear-step gears can be designed as fixed gears. In this case, the drive devices are connected to a fixed gear on the first transmission input shaft and/or to a fixed gear on the second transmission input shaft. The drive devices can therefore preferably be arranged in a P3 arrangement, i.e., at the transmission gear set.

Preferably, one drive device can be connected to the third gear stage.

Alternatively or additionally, a drive device can be attached to the single electric gear step.

Alternatively or additionally, a drive device can be attached to the fourth gear step. Alternatively or additionally, a drive device can be attached to the fifth gear step.

Preferably, the first drive device can be rotationally fixed to the internal combustion engine in all internal-combustion-engine forward gears and/or during an internal-combustion-engine gear change. In this case, a constant connection exists between the internal combustion engine and the first drive device during internal combustion engine-driven travel. Preferably, the first drive device can be utilized, at least intermittently, as a generator in all forward gears except for the crawler gear.

Preferably, the second drive device can be utilized for an electric or fluidic forward starting operation. In this case, the second drive device can be coupled, advantageously, to the gear-step gears of the second gear. The starting operation is always performed by the second drive device. The second drive device can preferably be utilized as a sole drive source for the starting operation. The second drive device can also be utilized for electric or fluidic travel in reverse. Preferably, it can also be provided here that the second drive device is the sole drive source during travel in reverse. In this case, there are no internal-combustion-engine or hybrid reverse gears.

Preferably, the drive devices can be arranged axially parallel to the first transmission input shaft. The drive devices are then preferably also axially parallel to the second transmission input shaft and to the countershaft. In the present invention, an axially parallel arrangement refers not only to completely parallel arrangements. An inclination or an angle between the longitudinal axis of the transmission input shafts and the longitudinal axis of the electric motor can also be present. Preferably, an angle is provided between the longitudinal axis of an electric motor and the longitudinal axis of the transmission input shafts of less than or equal to ten degrees (10°), further preferably less than five degrees (5°) and, in particular zero degrees (0°). Slight inclinations of the drive devices in comparison to the transmission can result for reasons related to installation space.

Preferably, the drive devices can be counter-rotatingly arranged. This means, the output shafts of the drive devices point toward different, opposite sides. If the first drive device has an output side on the left, the second drive device has an output side on the right or, if the viewing direction is changed, one drive device has the output side at the front and the other drive device has the output side at the rear. As a result, the engagement point of the drive devices at the hybrid transmission device are axially spaced apart and improved coverage in the axial direction is achieved.

Preferably, the axes of the drive devices in the installation position can be situated above the axis of the transmission input shaft. The installation position is always referenced in the following. During installation, the hybrid transmission device can also be upside down. Such positions are irrelevant for the following description, however. While the axially parallel arrangement also makes it possible for one of the drive devices to be located below the axis of the transmission input shaft, it is advantageously provided that the drive devices and, thereby, the axes of the drive devices are positioned above the transmission input shaft. In this arrangement, the packing density can be maximized.

In addition, the axes of the drive devices in the installation position can be situated on both sides of the axis of the transmission input shaft. Therefore, one of the drive devices and/or the axis of the one drive device are/is situated to the left of the axis of the transmission input shaft and the other(s) are/is situated to the right of the axis. Reference is made here to the view of the axes in cross-section.

Preferably, it can be provided that the axes of the drive devices in the installation position are arranged symmetrically with respect to the axis of the transmission input shaft. In particular, the axes of the drive devices are to be symmetrically arranged with respect to distance and angular position, wherein the angle is based on the perpendicular. The drive devices can be counter-rotatingly arranged without ruining the symmetrical arrangement, since the position of the axes is all that matters here.

Preferably, the axes of the drive devices in the installation position can be situated above the axes of one or multiple countershaft(s) and/or one or multiple output shaft(s). The drive devices are therefore situated above the aforementioned components of the spur gear drive arrangement. Alternatively, it can therefore be said that the axes of the drive devices in the installation position are the uppermost axes of the hybrid transmission device.

Preferably, the drive devices can be arranged offset in the circumferential direction. The circumferential direction is established with respect to the longitudinal axis of the transmission input shaft, which, by definition, is considered in the present invention to be the longitudinal axis of the hybrid transmission device.

It is preferred when the drive devices are arranged at least partially overlapping in the axial direction. Preferably, the overlap in the axial direction can be more than seventy-five percent (75%). If the drive devices should be of unequal length, the shorter drive device is used as the basis for calculating the overlap. The overlap is determined with reference to the housing of the drive devices. The output shaft of the drive devices is not taken into account.

The drive devices can be arranged in the axial direction preferably at the same level as the gear change transmission. Preferably, the overlap in the axial direction can be more than seventy-five percent 75%. Advantageously, the overlap in the axial direction is one hundred percent (100%). Here, the overlap is determined with reference to the housing of the drive devices and, in particular, of the housing of the longer drive device. The output shaft of the drive devices is not taken into account.

Preferably, the first drive device and/or the second drive device can be designed as an electric motor. Electric motors are widespread in hybrid transmission devices.

Alternatively or additionally, the first drive device and/or the second drive device can be designed as a fluid power machine. In addition to electric motors, there are other prime movers, the utilization of which in hybrid transmission devices is conceivable. These can also be operated as motors, i.e., in a manner that consumes energy, or as generators, i.e., in a manner that converts energy. In the case of a fluid power machine, the energy accumulator is, for example, a pressure reservoir. The energy conversion then consists of converting the energy from the internal combustion engine into a pressure build-up.

Advantageously, the first drive device and the second drive device can be power-shifted. A powershift is understood here, as usual, to mean that no interruption of tractive force occurs at the output of the hybrid transmission device during a gear change, for example, of the first drive device. A reduction of the torque present at the output is possible, but a complete interruption is not.

As a result, the motor vehicle can be continuously driven in large speed ranges, for example, exclusively electrically, wherein the ratio, i.e., the gear, is selected in each case so as to be optimized with respect to the rotational speed and torque of the drive device.

Preferably, the second drive device can output torque to the drive output while the first drive device is shifted. In other words, the gear step is changed, via which the first drive device transmits torque to the drive output.

Preferably, the first drive device can output torque to the drive output while the second drive device is shifted. This means, the gear step is changed, via which the second drive device transmits torque to the drive output. It may therefore also be stated that the drive devices are power shiftable with one another. The internal combustion engine therefore does not need to be started for a gear change during electric travel.

Preferably, at least one of the drive devices can be connected to the transmission via a P3 connection. Advantageously, both drive devices are connected to the transmission via this connection. In a P3 connection, the drive devices engage at the transmission between the input shaft and the output shaft.

Advantageously, both drive devices can be operatively connected to a differential via, at most, four meshing points. As a result, good efficiency is achieved.

Advantageously, a clutch can be present for connecting the first transmission input shaft to an internal combustion engine. This is advantageously arranged at the end of the first transmission input shaft facing the outer side and the internal combustion engine of the hybrid transmission device.

In addition, a clutch can be present for connecting the second transmission input shaft to the internal combustion engine. This is advantageously arranged at the end of the second transmission input shaft facing the outer side and the internal combustion engine of the hybrid transmission device.

Preferably, a connecting clutch can be provided for connecting the first transmission input shaft and the second transmission input shaft. This is utilized for coupling the sub-transmission. However, it is also a clutch for connecting the second transmission input shaft to the internal combustion engine, wherein the connection extends via the first transmission input shaft.

Preferably, the connecting clutch can be arranged at the end of the second transmission input shaft facing the transmission. As a result, it becomes possible to provide two clutches on the engine side, with which the first transmission input shaft as well as the second transmission input shaft are connectable to the internal combustion engine. As a result, it becomes possible, for example, to provide an electric motor-operated crawler gear or also to operate both electric motors together and, alternately, as generators.

Advantageously, the connecting clutch can be designed as part of a two-sided engagement device. The connecting clutch, due to positioning, is integratable into a two-sided engagement device.

In the present invention, an engagement device is understood to be an arrangement with one or two shift element(s). The engagement device is designed to be one-sided or two-sided. A shift element can be a clutch or a gearshift clutch. A clutch is utilized for connecting two shafts in a rotationally fixed manner and a gearshift clutch is utilized for rotationally fixing a shaft to a hub rotatably mounted thereon, for example, an idler gear. The connecting clutch, therefore, is designed as a gearshift clutch and, preferably, also as part of a gearshift clutch and is referred to as a clutch only because the gearshift clutch connects two shafts to each other. The clutches for connecting the transmission input shafts to the internal combustion engine connect the particular transmission input shaft to a crankshaft of the internal combustion engine.

Preferably, at least a portion of the clutches and/or gearshift clutches can be designed as dog clutches. In particular, all clutches and gearshift clutches can be designed as dog clutches.

Advantageously, at least one engagement device can be arranged on the first transmission input shaft. Preferably, at least two, in particular precisely two, engagement devices can be arranged on the first transmission input shaft. This can be advantageously designed as a two-sided engagement device. Alternatively, a one-sided engagement device and a two-sided engagement device can be provided.

Advantageously, the engagement devices enclose the second transmission input shaft.

One of the engagement devices on the first transmission input shaft preferably includes a gearshift clutch and a clutch.

Advantageously, the second transmission input shaft can be designed to be engagement device-free and/or idler gear-free. Preferably, at least one fixed gear can be arranged on the second transmission input shaft. In particular, at least two, in particular precisely two, fixed gears can be arranged on the second transmission input shaft.

Preferably, at least one, in particular precisely one, idler gear can be arranged on the first transmission input shaft.

Preferably, at least two, in particular precisely two, fixed gears can be arranged on the first transmission input shaft.

Advantageously, one fixed gear and one idler gear can be associated with each forward gear step and, in fact, a single fixed gear and a single idler gear in each case. In addition, each fixed gear and idler gear can always be unambiguously associated with a single forward gear step, i.e., there are no winding-path gears by utilizing one gearwheel for multiple gears. Nevertheless, the internal-combustion-engine forward gears two and four can be considered to be winding-path or coupling gears, as described below, since the first transmission input shaft is interconnected during the formation of the gears.

In one preferred example embodiment, the hybrid transmission device and/or the transmission can include precisely four two-sided engagement devices for producing five internal-combustion-engine gear stages, in particular forward gear stages. The connecting clutch advantageously forms a part of one of the two-sided engagement devices.

Preferably, a differential can be arranged in the axial direction at the level of one or two clutches for connecting a transmission input shaft to the internal combustion engine. Advantageously, a gearwheel for connecting the differential can be arranged axially externally on a countershaft. The connection can preferably take place at the side of the internal combustion engine.

Preferably, the hybrid transmission device can include at least one, in particular precisely one, countershaft. In the case that a single countershaft is utilized, a single point of connection to the differential is present. As a result, installation space can be saved, which is the case in the radial direction as well as in the axial direction.

Preferably, at least two, in particular precisely two, engagement devices can be arranged on the countershaft. In addition, advantageously, precisely four idler gears can be arranged on the countershaft. Advantageously, all the engagement devices on the countershaft can be designed to be two-sided.

The engagement devices arranged on the countershaft can be arranged offset in the axial direction with respect to one or multiple engagement device(s) on one of the transmission input shafts, in particular the first transmission input shaft. In particular, the engagement devices arranged on the countershaft can enclose an engagement device on the first transmission input shaft in the axial direction. This means, the engagement devices arranged on the countershaft and the engagement device on the first transmission input shaft are not only axially offset, but rather that the one engagement device on the countershaft is located to the left of the engagement device on the first transmission input shaft and the other to the right thereof, as viewed in a gear set scheme. When the transmission is viewed in the direction longitudinally to the transmission, the one engagement device is situated in front of the engagement device and the other behind the engagement device on the first transmission input shaft. The enclosed engagement device is advantageously arranged at one end of the second transmission input shaft.

Preferably, all shift elements of the engagement devices on the countershaft can be designed as gearshift clutches.

Preferably, at least one, in particular precisely one, fixed gear can be located on the countershaft for forming a forward gear step. In addition, a fixed gear can be located on the countershaft for establishing a connection to the differential. However, this is not a fixed gear for forming a forward gear step.

Advantageously, a single fixed gear for forming a forward gear step can be arranged on the countershaft, and at least one idler gear can be arranged on both sides of the fixed gear. Preferably, at least two, in particular precisely two, idler gears are located on both sides of the fixed gear.

In addition, the hybrid transmission device can include a control device. The control device is designed for controlling the transmission as described.

Example aspects of the invention also relate to a motor vehicle with an internal combustion engine and a hybrid transmission device. The motor vehicle is distinguished by the fact that the hybrid transmission device is designed as described.

Advantageously, the hybrid transmission device is arranged in the motor vehicle as a front-mounted transverse transmission device.

Preferably, the motor vehicle includes a control device for the open-loop control of the hybrid transmission device. The control device can therefore be part of the hybrid transmission device, although control device does not need to be part of the hybrid transmission device.

Preferably, a battery is arranged in the motor vehicle, which allows for an electric operation of the motor vehicle for at least fifteen (15) minutes. Alternatively, for a purely electric operation, the internal combustion engine, with one of the electric motors as a generator, can generate current, which goes directly to the other electric motor.

In addition, the motor vehicle can include a pressure reservoir. This can be utilized for operating a fluid power machine.

### BRIEF DESCRIPTION OF THE DRAWINGS

Further advantages, features, and details of the invention result from the following description of exemplary embodiments and figures, in which:

FIG. 1 shows a motor vehicle;

FIG. 2 shows a first example gear set scheme;

FIG. 3 shows a circuit diagram;

FIG. 4 shows a second example gear set scheme; and

FIG. 5 shows the hybrid transmission device in a side view.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

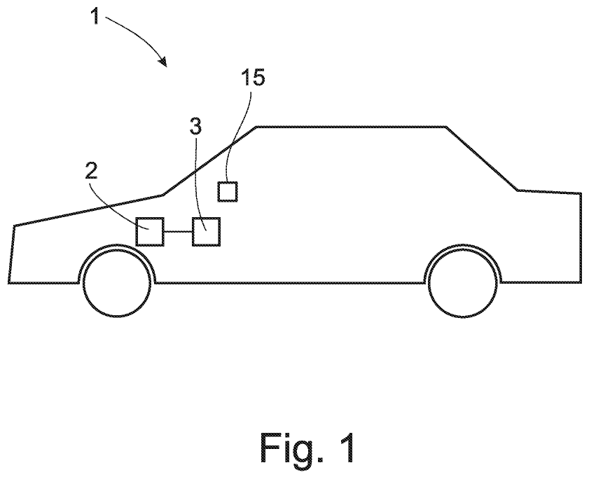

FIG. 1 shows a motor vehicle 1 with an internal combustion engine 2 and a hybrid transmission device 3. The hybrid transmission device 3 also includes, as described in greater detail further below, electric motors and a clutch device, and so the hybrid transmission device 3 can be installed as an assembly unit. This is not absolutely necessary, however. In principle, the gear set can form an assembly unit even without a previously connected clutch assembly and the electric motors. A control device 15 is provided for the open-loop control of the hybrid transmission device 3. This can be part of the hybrid transmission device 3 or of the motor vehicle 1.

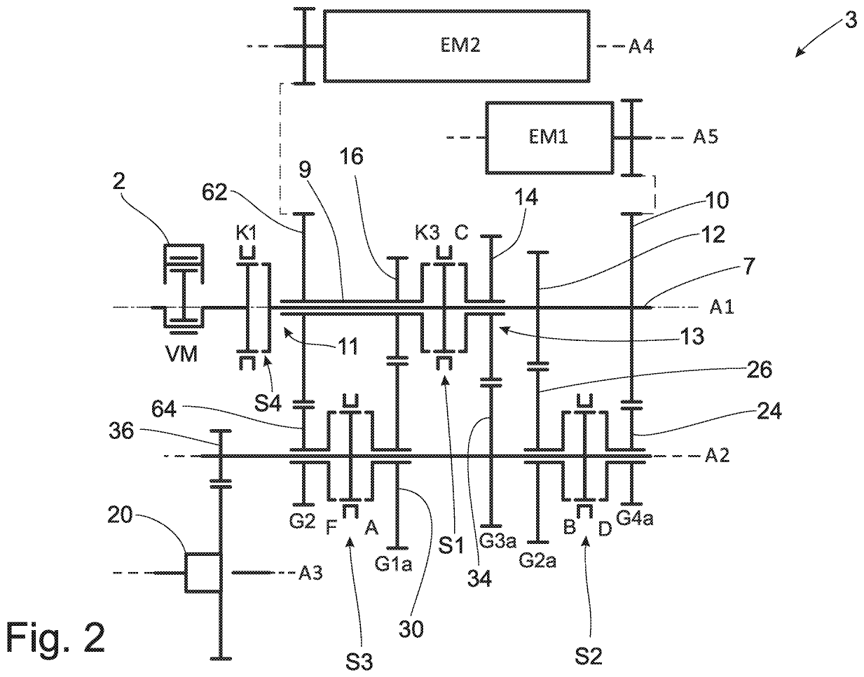

FIG. 2 shows the hybrid transmission device 3 and, in particular, the gear change transmission 4 in a schematic as a gear set scheme. In the following, the hybrid transmission device 3 will be described starting from the internal combustion engine 2. The clutch K1, as the engagement device S4, is attached at the crankshaft 5 on the input side. The output part 6 of the clutch K1 is connected to the first transmission input shaft 7. A second transmission input shaft 9 is mounted on the first transmission input shaft 7. Two fixed gears 16 and 62 are arranged on the second transmission input shaft 9. The fixed gear 16 is the fixed gear of the first gear and the fixed gear 62 is the fixed gear of the second electric gear GE2.

The second transmission input shaft 9 has two ends, namely one end 11 pointing toward the outer side of the hybrid transmission device 3 and one end 13 pointing toward the inner side of the hybrid transmission device 3.

The engagement device S1 with a clutch K3 and a gearshift clutch C mounted on the transmission input shaft 7 follows. By the gearshift clutch C, the idler gear 14 can be rotationally fixed to the transmission input shaft 7. The idler gear 14 is the idler gear of the third gear.

Arranged thereafter on the transmission input shaft are the fixed gears 12 and 10, wherein the fixed gear 12 represents the fixed gear of the second gear and the fixed gear 10 represents the fixed gear of the fourth gear.

The second transmission input shaft 9 is therefore designed to be shift element-free and idler gear-free. The engagement devices S1 and S4 are arranged on the first transmission input shaft 7, wherein the engagement device S1 includes the clutch K3 and the gearshift clutch C and, therefore, is designed to be two-sided.

The axis of rotation of the first transmission input shaft 7 and of the second transmission input shaft 9 is labeled with A1.

The hybrid transmission device 3 includes a single countershaft 22 for connection to a differential 20 and to form the gear stages or gear steps. Two shift elements S2 and S3 with the gearshift clutches A, B, D, and F are arranged on the countershaft 22 for connecting the idler gears 24, 26, 30, and 64 to the countershaft 22. As the only gear-implementing fixed gear, the fixed gear 34 is located between the idler gears 24, 26, 30, and 32 on the countershaft 22. The assignment to the gears results on the basis of the gear numbers below the gearwheels arranged on the countershaft 22 and via the above-described arrangement on the transmission input shafts 7 and 9.

The fixed gear 36 is not a gear-implementing fixed gear. The fixed gear 36 connects the countershaft 22 to the differential 20 as a drive output constant. On the basis of this scheme, the following can be established with respect to the internal-combustion-engine and electric forward gears V1, V2, V3, V4, E1, and E2:

A fixed gear and an idler gear are associated with each gear step G1 through G4 and GE2 and, in fact, a single fixed gear and a single idler gear in each case. Each fixed gear and idler gear are always unambiguously associated with a single forward gear or a single gear step, i.e., there are no winding-path gears by utilizing one gearwheel for multiple gears. Nevertheless, the gear steps 1 and GE2 can be considered to be coupling gears, since the first transmission input shaft 7 is interconnected during the formation of the gears.

The electric motors EM1 and EM2 are attached as shown and, in fact, at the axially external gearwheels 10 and 62. As a result, it is possible to attach the electric motors 1 and 2 without additional gearwheels on one of the transmission input shafts 7 and 9, as the result of which installation space is saved. In particular, due to the attachment of the electric motors EM1 and EM2 at the axially outermost gearwheels 10 and 62, an axially extremely short transmission device can be created.

The electric motors EM1 and EM2 are arranged in parallel to the transmission input shaft 7 and the electric motors EM1 and EM2 have an output at opposite sides. This means, as shown in FIG. 2, the output and/or the output shaft 31 of the electric motor EM1 points toward the end 35 of the gear set 4 facing away from the motor and the output shaft 33 of the electric motor EM2 points toward the end 37 of the gear set 4 facing the motor. In FIG. 2, one end therefore points toward the left and one end points toward the right. The electric motors EM1 and EM2 are arranged partially overlapping in the axial direction, and so the hybrid transmission device 3, in the area of the electric motors EM1 and EM2, takes up only approximately the length occupied by a single electric motor. Due to the above-described arrangement of the shift elements S1, S2, S3, and S4 and the design of the reverse gear without a reversing gearwheel, a length of the hybrid transmission device 3 of slightly more than thirty centimeters (30 cm) is made possible.

The electric motors EM1 and EM2 are power shiftable with each other in this configuration as well.

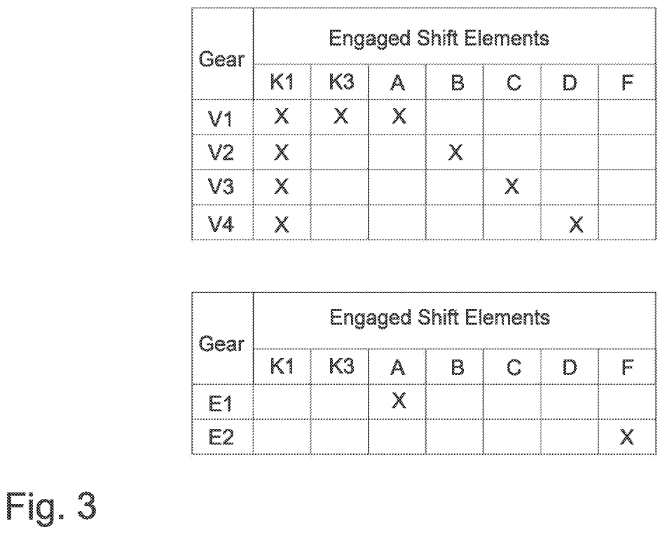

FIG. 3 shows a circuit diagram of the hybrid transmission device 3 according to FIG. 2, from which it arises, for example, that the clutch K3 connects the input shafts 7 and 9 of the sub-transmissions 36 and 38 in order to form the internal-combustion-engine gear V1.

The gearshift clutch A is utilized for selecting the electric gear E1 by utilizing the gear step G1 and the gearshift clutch F is utilized for selecting the electric gear E2 by utilizing the gear step GE2.

The particular engaged shift elements are marked by “X”.

The shift element F is the shift element of the mechanical gear GE2, which is utilized only with the electric motor EM2.

Four internal-combustion-engine forward gears V1, V2, V3, and V4 and at least two electric gears E1 and E2 are implemented. The internal-combustion-engine forward gears V1, V2, V3, and V4 and the electric forward gear E1 are formed via the corresponding mechanical gear steps G1, G2, G3, and G4, i.e., E1 and V1 with G1, V2 with G2, etc. The electric gear E2, however, has separate gear-step gearwheels 62 and 64 of the gear step GE2.

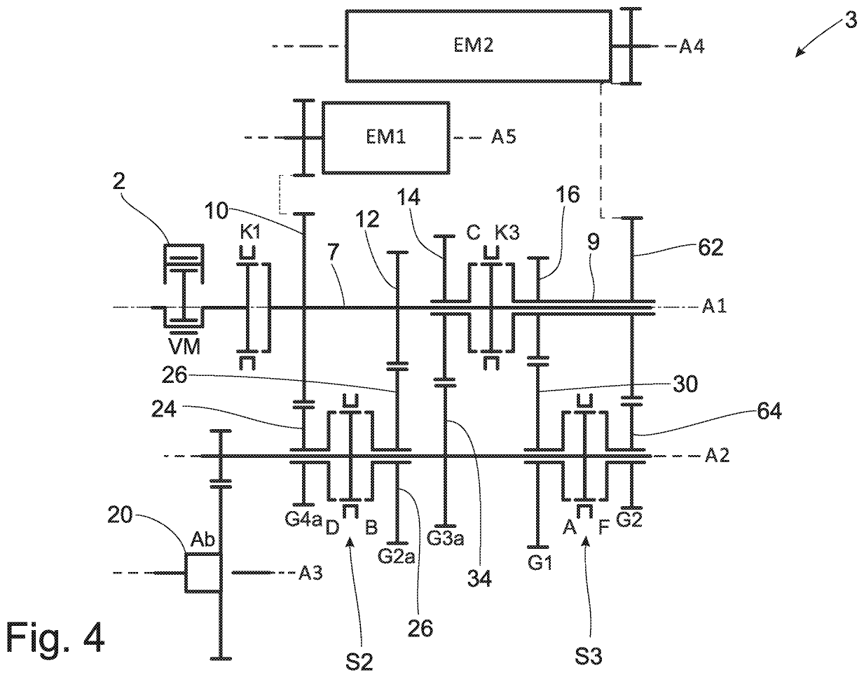

FIG. 4 shows the hybrid transmission device 3 according to FIG. 2, wherein this was designed as a mirror image with respect to the central axis, which extends through the gearwheels 14 and 34 of the gear G3. From a purely functional perspective, the hybrid transmission devices 3 according to FIGS. 2 and 4 do not differ.

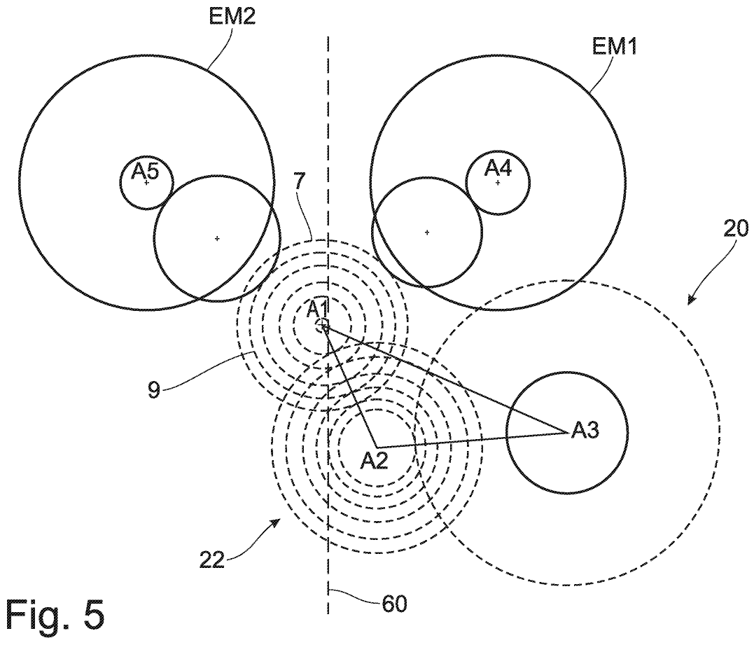

FIG. 5 shows a side view of the transmission according to one of FIG. 2 or 4. The axes A4 and A5 of the electric motors EM1 and EM2 are arranged above and laterally with respect to the axis A1 of the first transmission input shaft 7 and also of the second transmission input shaft 9. The axis A2 of the countershaft 22 and the axis A3 of the differential are advantageously situated below the axis A1 of the first transmission input shaft 7. The axes A4 and A5 are arranged symmetrically with respect to the axis A1 in such a way that the distance of the axes A4 and A5 to the axis A1 is identical and the angle with respect to the perpendicular 60 is also identical.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

1 motor vehicle
2 internal combustion engine
3 hybrid transmission device
4 gear set
5 crankshaft
6 output part
7 first transmission input shaft
8 output part
9 second transmission input shaft
10 fixed gear
11 end
12 fixed gear
13 end
14 idler gear
15 control device
16 fixed gear
18 fixed gear
20 differential
22 countershaft
24 idler gear
26 idler gear
30 idler gear
31 output shaft
32 idler gear
33 output shaft
34 fixed gear
35 end facing away from the motor
36 sub-transmission
37 end facing the motor
38 sub-transmission
40 curve
41 motor speed
42 motor speed
43 curve
44 initial value
46 initial value
48 target value
50 target value
52 target value
53 output torque
54 curve
60 perpendicular
K1 clutch
K2 clutch
K3 clutch
S1 engagement device
S2 engagement device
S3 engagement device
S4 engagement device
A gearshift clutch
B gearshift clutch
C gearshift clutch
D gearshift clutch
E gearshift clutch
EM1 electric motor
EM2 electric motor
A1 axis
A2 axis
A3 axis
A4 axis
A5 axis

1-15: (canceled)

16. A method for operating a motor vehicle (1) that includes an internal combustion engine (2) and a hybrid transmission device (3), the hybrid transmission device (3) including a gear change transmission (4) with a plurality of gear stages (G1, G2, G3, G4, GE2) and at least one drive device (EM2), the method comprising:
applying drive torque exclusively by the at least one drive device (EM2) of the hybrid transmission device (3) in at least one gear step (GE2).

17. The method of claim 16, wherein the drive torque is applied exclusively by the at least one drive device (EM2) of the hybrid transmission device (3) in precisely one gear step (GE2).

18. The method of claim 16, further comprising applying the drive torque by the at least one drive device (EM1, EM2) of the hybrid transmission device (3) and the internal combustion engine in at least one other gear step (G1, G2, G3, G4).

19. The method of claim 16, further comprising applying the drive torque simultaneously by the at least one drive device (EM1, EM2) of the hybrid transmission device (3) and the internal combustion engine in at least one other gear step (G1, G2, G3, G4).

20. The method of claim 16, wherein precisely four gear steps (G1, G2, G3, G4) are operated by the internal combustion engine.

21. The method of claim 16, wherein the gear change transmission (4) comprises at least two sub-transmissions (36, 38).

22. The method of claim 16, wherein the hybrid transmission device (3) comprises at least two drive devices (EM1, EM2), and the method further comprises connecting a first drive device (EM1) of the at least two drive devices (EM1, EM2) to the internal combustion engine (2) in all internal-combustion-engine forward gears (V1, V2, V3, V4).

23. The method of claim 16, wherein the hybrid transmission device (3) comprises at least two drive devices (EM1, EM2), and the method further comprises connecting a first drive device (EM1) of the at least two drive devices (EM1, EM2) to the internal combustion engine (2) in all hybrid forward gears (H22, H32, H34, H44, H54).

24. The method of claim 16, wherein the hybrid transmission device (3) comprises at least two drive devices (EM1, EM2), and the method further comprises using a second drive device (EM2) of the at least two drive devices (EM1, EM2) to pull away from rest in a forward direction.

25. The method of claim 16, wherein the hybrid transmission device (3) comprises at least two drive devices (EM1, EM2), and the method further comprises using a second drive device (EM2) of the at least two drive devices (EM1, EM2) for travel in reverse.

26. The method of claim 16, wherein the gear change transmission (4) comprises at least two sub-transmissions (36, 38), and the two sub-transmissions (36, 38) are connected in order to form one or both of an internal-combustion-engine forward gear and a hybrid forward gear (V1, V2, V3, V4, H22, H32, H34, H44).

27. The method of claim 16, wherein one or both of:
a first electric motor (EM1) of the at least one drive device is utilized as a first drive device; and
a second electric motor (EM2) of the at least one drive device is utilized as a second drive device.

28. A control device for a motor vehicle, wherein the control device (15) is configured for carrying out the method of claim 16.

29. A motor vehicle (1), comprising:
the internal combustion engine (2);
the hybrid transmission device (3) with two drive devices (EM1, EM2); and
the control device (15) of claim 28.

30. The motor vehicle (1) of claim 29, wherein the hybrid transmission device (3) is configured as a front-mounted transverse transmission device.
